(19) United States
(12) Patent Application Publication
(10) Pub. No.: US 2013/0081633 A1
(43) Pub. Date: Apr. 4, 2013

(54) PASSENGER OXYGEN MASK

(71) Applicant: B/E Aerospace Systems GmbH, Lubeck (DE)

(72) Inventor: Marco Silvi ANTONINI, Lubeck (DE)

(73) Assignee: B/E AEROSPACE SYSTEMS GMBH, Lubeck (DE)

(21) Appl. No.: 13/630,423

(22) Filed: Sep. 28, 2012

(30) Foreign Application Priority Data
Sep. 30, 2011 (DE) 10 2011 083 869.4

(51) Int. Cl. A62B 18/08

(52) U.S. Cl. 128/206.27

(57) ABSTRACT

A passenger oxygen mask includes a carrier body and an annular holder which is provided on the carrier body and which is with an opening for fastening a pull device. A slot through which the pull device can be introduced into the opening is provided in the annular holder.

### CROSS REFERENCE TO RELATED APPLICATIONS

This application claims the benefit of priority under 35 U.S.C. §119 of German Patent Application DE 10 2011 083 869.4 filed Sep. 30, 2011, the entire contents of which are incorporated herein by reference.

### FIELD OF THE INVENTION

The invention relates to a passenger oxygen mask with a carrier body and with an annular holder which is provided on the carrier body and which includes an opening for fastening a pull means. The invention moreover relates to a pull means for a passenger oxygen mask, as well as to such a mask with a pull means.

### BACKGROUND OF THE INVENTION

Oxygen emergency supply devices are available in aircraft, in order to be able to provide passengers and service personnel with oxygen given a sudden pressure drop in the cabin. These, in the passenger region, are located in the so-called personal service unit channels or regions which are arranged on the cabin ceiling above the passenger seats. For this, apart from the feed or air of the air-conditioning installation, electrical displays, the lighting etc., receptacles for accommodating breathing masks for the oxygen supply and their activation mechanics are provided in the personal service unit channels. These receptacles arranged in the personal service unit channels, on the lower side comprise flaps which open in the case of decompression of the passenger cabin, so that the breathing masks, hanging on so-called lanyards, fall down on account of gravity. The oxygen supply is then activated via the lanyard. This is to be understood as a pull means which is attached between the mask and the activation mechanism of the oxygen supply. The mask is connected to the oxygen supply by way of a supply tubing.

At present, the lanyards are connected to the mask body with a spring ring or snap hook. This necessitates a relatively large assembly effort and finger dexterity of the fitter or installer, with the given production numbers. Moreover, according to experience, the spring constant of the snap hooks is not constant after the assembly and thus creates a safety risk entailing further time-extensive control work.

### SUMMARY OF THE INVENTION

It is an object of the present invention to solve the problems mentioned above and to provide a connection between a passenger oxygen mask and a pull means for activating an oxygen supply to the mask, which permits a quicker assembly between the pull means and the mask body with a simultaneous reduction of the components whilst keeping to the AS8025 passenger oxygen mask standard and which at the same time is simply constructed, at the same time reliable and is also yet inexpensive.

According to the invention, a passenger oxygen mask comprises a carrier body and a breathing bag which is fastened thereto and to which an oxygen tubing connects, via which tubing the mask is connected to the oxygen supply. The pull (means as is usual) is fastened on the carrier body and is connected to an activation or release mechanism for the oxygen supply. A holder (referred to as an annular holder) for fastening the pull means on the carrier body is provided on the carrier body and comprises an a through passage with an opening. A slot is provided in the annular holder, through which slot the pull means can be introduced into the opening. A slot in the context of this invention is to be understood as any recess, through which the pull means can be introduced into the opening of the annular holder, without threading this pull means through the opening itself. Such a slot therefore in the simplest form can be a straight recesses in the wall of the annular holder, but it can also be formed by a labyrinth-like recess or one which changes its direction once or several times. A passenger oxygen mask designed in such a manner permits an extremely rapid and thereby simultaneously reliable fastening of the pull means—hereinafter also called lanyard—on the mask body, since the pull means does not need to be threaded by the fitter in the direction of the opening, but led via the slot laterally through the annular holder and thus the region of the opening and then merely be pulled into this opening. The connection between the mask and the lanyard can thereby be secured basically by way of e.g. pressing or bonding both parts, by way of a pin securing or screw securing, with the help of a bayonet closure or by way of a combination of several of these mentioned measures. By way of this, one prevents the pull means from being pulled out in the emergency case and/or from it slipping out of the holder when the mask is not used over a longer period of time, by way of it, despite this, being subjected to vibration and impacts. In all cases, a simple, rapid and reliable fastening of the lanyard on the mask body is possible due to the holder according to the invention.

However, it is particularly preferable for the opening to taper in a funnel-like manner in a pulling direction of the pull means, so that the pull means provided e.g. with a suitably shaped end-piece is prevented from being pulled out in this direction. Thus a failure of the connection in the case of an emergency is securely ruled out. Moreover, a pressing of the two parts against one another can be created in this way and manner. This can arise if the pull means is pulled into the holder e.g. in an abrupt manner, so that an adequately high pressing force between both parts arises, which reliably prevents the pull means from slipping out opposite to its pulling direction.

A particular advantage results due to the fact that the opening in a pull direction of the pull means comprises an abutment which prevents the pull means from being pulled out in this direction. Thus on the one hand a pulling-out in the emergency case is reliably ruled out and moreover the fitter is made aware of the fact that the end-piece has reached a secure seating in the holder, as soon as this holder blocks against this abutment.

The assembly procedure is considerably simplified if the slot extends parallel to a longitudinal axis of the opening. A pull cord or rip cord of the lanyard can be applied into the opening in a particularly rapid manner via this slot, and the lanyard can subsequently be pulled into the holder.

In a preferred manner, the connection is secured by way of the holder comprising means for fixing the pull means in the holder, said means securely preventing the pull means from slipping out of the holder. Such a connection can thus be created by way of a simple pulling of the lanyard into the holder, by which means no further working step is necessary for securing the connection. Moreover, a final checking of the connection with regard to a reliable seating of the pull means is rendered superfluous.

These means thereby, depending on the requirements, can be formed on the opening and/or slot of the holder, or formed by the shape of the slot itself and for example comprise a locking step and/or at least one spring tongue. Such a mask snap-connection produces a click noise, which signalises the secure seating of the pull means in the holder to the fitter, by way of which any faulty assembly or fitting is ruled out.

Alternatively or additionally, these means can be realised by way of a labyrinth-like shaping of the slot, which prevents the pull means from slipping out of the holder. For this, the slot e.g. can be designed in an S-shaped or M-shaped manner, but whatever the case, designed such that a slipping of the pull means out of the holder transversely to its pulling direction is reliably prevented.

Although the holder can be screwed, bonded or fastened on the carrier body in another way and manner, it is preferable to inject (injection mould) this on the carrier body. The integrated design of the holder with the carrier body increases the reliability of the connection between the lanyard and the mask body and moreover can be created in a particularly simple and inexpensive manner.

The pull means according to the invention comprises a pull cord or rip cord and an end-piece which is formed thereon in a plug-like manner, which increases the handing ability by the assembler who can grip and align the pull means in a simpler manner. Thereby, it is advantageous if the lateral edges of the plug-like end-piece are provided with chamfers, in order to simply the introduction of this into the holder. The side surfaces of this end-piece can moreover be designed tapering conically in the pull direction of the lanyard, for the self-centring of the end-piece in the holder.

The end-piece comprises locking means for locking on the mask, in order to rule out the end-piece from slipping out of the holder opposite to the pull direction of the lanyard, even if the mask is not to be used for a longer time. Thereby, it is preferable for the locking means to comprise at least one locking step and/or at least one spring tongue, which ensures a mechanically stable, non-releasable connection, which on assembly is moreover signalised by way of a click noise. Thereby, the locking means can be provided in the end-piece or on the holder or also on both parts as the case can be.

The end-piece is also preferably injected on the pull cord or rip cord, for the same reasons as have already been mentioned with regard to the fastening of the holder on the carrier body.

With this subassembly or module according to the invention, the end-piece of the pull means is designed on the mask with a positive fit to the opening of the holder, which ensures a particularly reliable seating of the lanyard on the mask.

A slipping-out of this end-piece opposite to the pull direction of the lanyard is prevented by way of the opening of the holder comprising locking means which when the end-piece is introduced into the opening, engage into locking means which are designed complementarily to this and are on the end-piece of the pull means.

Alternatively or additionally, the slot of the holder can have a labyrinth-like shape, so that the pull cord or rip cord is captively arranged in the slot. A slipping-out of the lanyard transversely to its pull direction is also reliably prevented by way of this, since this is blocked by the labyrinth-like slot.

For connecting a passenger oxygen mask to a pull means for releasing an oxygen supply, the mask comprises an annular holder with an opening, in which a slot is provided, and with which the pull means is introduced into the opening via the slot and locked. With this, the pull means or lanyard can be fastened on the mask in a particularly simple and rapid manner and—as already explained above—secured in a different way and manner.

Thereby, it is preferable for the pull means to be pulled so far into the holder, until it is blocked in the pull direction. On the one hand, the secure seating of the holder is reliably indicated by way of this and a pulling-out beyond this is reliably ruled out in the emergency case.

The pull means is preferably secured, in order to prevent it slipping out opposite to its pull direction. This can be ensured by way of different measures, as have likewise been previously described. However, it is particularly preferable if a so-called mask snap connection is provided, which on the one hand is particularly reliable and on the other hand signals by way of a click, as to when the end-piece has reached its secure seating in the holder.

The present invention is hereinafter explained in more detail by way of an embodiment example with reference to the accompanying figures. The same parts or parts acting equally are provided with the same reference numerals. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a perspective view obliquely from above onto a carrier body of a passenger oxygen mask, with a connection between a lanyard and a holder, according to the invention;

FIG. 2A is a lateral view of the carrier body of FIG. 1, with which it is indicated how a pull cord or rip cord of the lanyard is threaded into the holder;

FIG. 2B is a lateral view of the carrier body of FIG. 2A, with which it is indicated how an end-piece of the lanyards is pulled into the holder; and

FIG. 2C is a perspective view obliquely from above, onto a part of the carrier body of FIG. 1, with a lanyard which is pulled therein and is secured.

### DESCRIPTION OF THE PREFERRED EMBODIMENTS

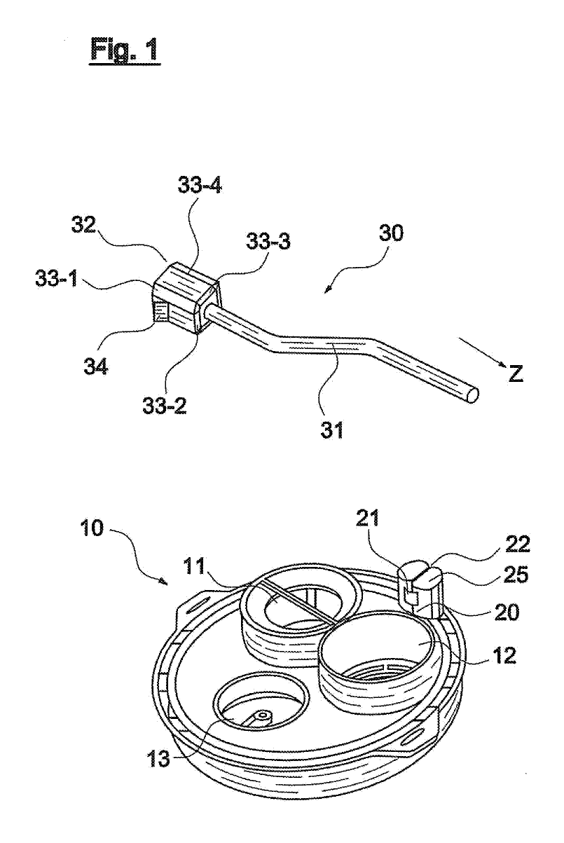

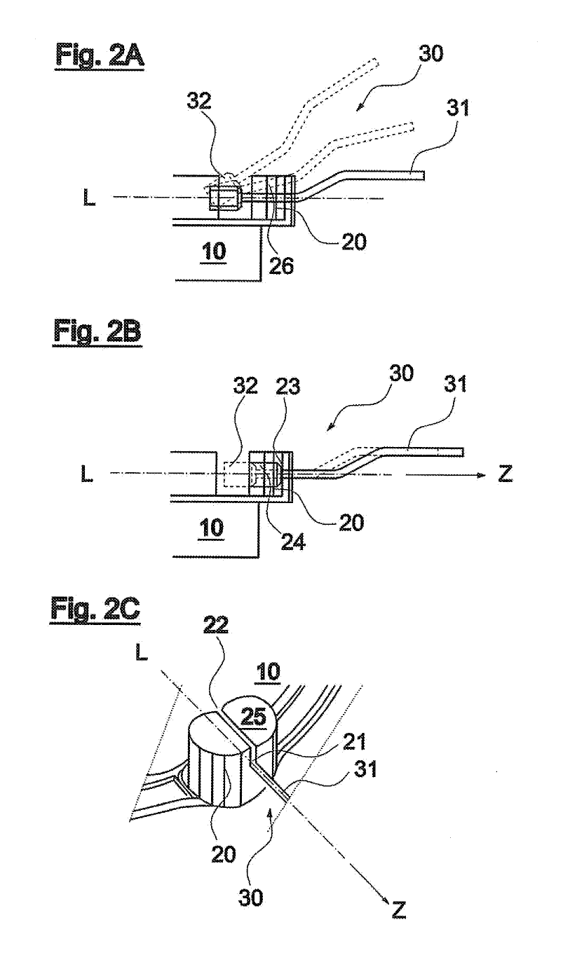

Referring to the drawings in particular, FIG. 1 shows a perspective view obliquely from above onto a carrier body 10 of a passenger oxygen mask with a holder 20 and a lanyard 30 which is fastened thereon. The carrier body 10 of the mask comprises an inhalation valve 11, an exhalation valve 12 and an air vent valve 13. The annular holder 20 for the lanyard 30 in this example is injected onto the carrier body 10, which ensures that the connection can be easily manufactured and has a high stability. The lanyard 30 comprises a pull cord or rip cord 31, on which an end-piece 32 is attached. The end-piece 32 is provided with locking means which here are formed as a spring tongue or as a latch 34 which locks in an elastically resilient manner into a locking step 24 (represented in FIGS. 2A and 2B) of an opening 21 of the trough passage of the holder 20. With this, the mask can be subjected to vibrations and impacts also over a longer period of not being used, without the risk of functional restrictions. Also several of these spring tongues or latches 34 and associated locking steps 24 can be provided, in order to yet further increase the safety against a slipping of the end-piece 32 out of the holder 20.

A pull cord or rip cord 31 of the lanyard 30 is applied via a slot (slot passage) 22 in the holder 20 into the opening 21, and thereafter the end-piece 32 of the lanyard 30 is pulled into the opening 21 of the holder 20, for fastening the lanyard 30 on the carrier body 10 of the mask. Thereby the slot 22 is incorporated in an outer surface 25 of the holder 20 which is at the top in FIG. 1, but may also be provided laterally of the holder 20, depending on which is most favorable for the assembly process. The edges of the end-piece 32 which is designed in a plug-like manner are provided with chamfers 33-1 . . . 33-4, in order to ensure a simple introduction of the end-piece 32 into the holder 20.

The end-piece 32 is injected (injection moulded) onto the pull cord or rip cord 31, which likewise ensures a simple manufacture and a high stability of the connection. The locking step 24 can be reached via a groove 26 which is incorporated in the opening 21 and in which the spring tongue or the catch 34 is led until locking into the locking step 24, in order to ensure a correct position of the spring tongue or of the catch 34 with respect to the locking step 24 in the opening 21 Additionally or alternatively, the plug-like end-piece 32 can however also have a cross section which permits it to be inserted into the holder 20 only in a certain rotational position to the opening 21.

FIG. 2A shows a lateral view of the carrier body 10 of FIG. 1, in which it is represented how a pull cord or rip cord 31 of the lanyard 30 is applied into the holder 20. The dashed lines show the respective course of the pull cord or rip cord 31 during the insertion process.

FIG. 2B shows the lateral view of the carrier body 10 as FIG. 2A, in which it is represented as to how the end-piece 32 of the lanyard 30 is pulled into the holder 20. This is effected in the pulling direction Z along a longitudinal axis L of the opening 21, wherein the end-piece 32 on the pull cord or rip cord 31 is pulled into the opening 21 until it is blocked against an abutment 23. The end-piece 32 and thus the lanyard 30 are thus secured against being pulled out of the holder 20 given the emergency case. The spring tongue or the catch 34 during the pulling-in of the end-piece 32 is led in a groove 26 (indicated in FIG. 2A), until it locks into the locking step 24 and is secured from slipping out. With this, a very rapid and simple, but at the same time extremely reliably connection between the mask and the lanyard 30 arises.

FIG. 2C shows a perspective view obliquely from above, onto a part of the carrier body 10 of FIG. 1 with a lanyard 30 which is pulled therein and secured. In this case, once again the position of the slot 22 in the outer surface 25 of the holder 20 is clearly recognizable and this slot runs parallel to the longitudinal axis L of the opening 21. The pull cord or rip cord 31 of the lanyard 30 is aligned in the pulling direction Z and under a pull or tensile loading activates an oxygen feed via an oxygen conduit (not shown) to the mask. The end-piece 32 of the lanyard 30 is centered in the opening 21 via the slot 22 provided in the holder 20. The end-piece 32 is pulled up to the abutment 23 of the holder 20, wherein the spring tongue or latch 34 is locked in. This reliably prevents a slipping-out of the end-piece 32 even over a longer period of time due to the mask not being used, but being subjected to vibrations and impacts. For activating the oxygen system, one pulls on the mask and a tension or pull force is transmitted via the lanyard 30 onto a starter pin of the oxygen supply. In the emergency case, this pull force is introduced such that the lanyard 30 seeks to be pulled out of the centered position through the slot 22 of the holder 20. The latch mechanism and positive-fit between the end-piece 32 and the holder 20 however renders a threading-out of the lanyard 30 impossible in this case.

Although the present invention has been explained with regard to the connection of a passenger oxygen mask to a lanyard, it is in no way limited to this, but can basically be used anywhere where it is a question of the simple and rapid and thereby simultaneously inexpensive connection of components which are to meet the most demanding of reliability requirements.

While specific embodiments of the invention have been shown and described in detail to illustrate the application of the principles of the invention, it will be understood that the invention may be embodied otherwise without departing from such principles.

### APPENDIX

### List of Reference Numerals

10 carrier body
11 inhalation valve
12 exhalation valve
13 air vent valve
20 holder
21 opening
22 slot
23 abutment
24 locking step
25 outer side
26 groove
30 pull device
31 pull cord or rip cord
32 end-piece
33-1 . . . 33-4 chamfers
64 spring tongue
L longitudinal axis of the opening 21
Z pull direction of the pull device 30

What is claimed is:

1. A passenger oxygen mask comprising:
a carrier body;
an annular holder provided on the carrier body, the annular holder having an opening and a slot; and
a pull device, the opening of the annular holder for fastening the pull device, the slot defining a passage through which slot the pull device can be introduced into the opening.

2. A mask according to claim 1, wherein the opening tapers in a funnel-like manner in a pull direction of the pull device.

3. A mask according to claim 1, wherein the opening in the pull direction of the pull device comprises an abutment.

4. A mask according to claim 1, wherein the slot extends parallel to a longitudinal axis of the opening.

5. A mask according to claim 1, further comprising a fixing means for fixing the pull device in the holder.

6. A mask according to claim 5, wherein the fixing means and the pull device are formed on the opening and/or on the slot.

7. A mask according to claim 6, wherein the fixing means and the pull device comprise at least one locking step and/or at least one spring tongue.

8. A mask according to claim 7, wherein the means for fixing the pull device are formed by way of a labyrinth-like shaping of the slot.

9. A mask according to claim 1, wherein the holder is injected on the carrier body.

10. A pull device for a passenger oxygen mask with a carrier body and an annular holder provided on the carrier body, the annular holder having an opening and a slot, the pull device comprising:
a pull cord or rip cord; and
an end-piece formed thereon in a plug-like manner are provided.

11. A pull device according to claim 10, wherein lateral edges of the end-piece are provided with chamfers.

12. A pull device according to claim 10, wherein side surfaces of the end-piece conically taper in the pull direction.

13. A pull device according to claim 10, wherein the end-piece comprises a fixing means for fixing on the mask.

14. A pull device according to claim 13, wherein the means for fixing comprise at least one locking step and/or at least one spring tongue.

15. A pull device according to claim 10, wherein the end-piece is injected on the pull cord or rip cord.

16. A passenger oxygen mask comprising:
a carrier body;
a holder fixed to the carrier body, the holder having a through passage with an opening and a slot defining a slot passage extending from a holder outer surface to the through passage; and
a pull device introduced into the through passage via the slot passage, the holder fastening the pull device by interaction with the pull device in a region of the opening of the through passage.

17. A passenger oxygen mask according to claim 16, wherein an end-piece of the pull device forms a positive fit to a surface of the opening of the through passage of the holder.

18. A subassembly comprising a passenger oxygen mask comprising:
a carrier body;
an annular holder provided on the carrier body, the annular holder having an opening and a slot;
a pull device, the opening of the annular holder for fastening the pull device, the slot defining a passage through which slot the pull device can be introduced into the opening wherein an end-piece of the pull device forms a positive fit to a surface of the opening of the through passage of the holder.

19. A subassembly according to claim 18, wherein the opening of the holder comprises locking means which, when the endpiece is inserted into the opening, engages into locking means which are designed complementarily thereto and are on the end-piece of the pull device.

20. A subassembly according to claim 18, wherein the slot of the holder has a labyrinth-like shape which fixes the pull cord or rip cord in the slot.
